(19) United States
(12) Patent Application Publication
(10) Pub. No.: US 2018/0202529 A1
(43) Pub. Date: Jul. 19, 2018

(54) TRANSMISSION ARRANGEMENT FOR A MOTOR VEHICLE

(71) Applicant: SCHAEFFLER TECHNOLOGIES AG & CO. KG, Herzogenaurach (DE)

(72) Inventors: Inaki FERNANDEZ, Nuernberg (DE); Harald MARTINI, Herzogenaurach (DE); Thorsten BIERMANN, Wachenroth (DE); Philip WURZBERGER, Nuernberg (DE)

(73) Assignee: SCHAEFFLER TECHNOLOGIES AG & CO. KG, Herzogenaurach (DE)

(21) Appl. No.: 15/741,959

(22) PCT Filed: May 27, 2016
(86) PCT No.: PCT/DE2016/200254

§ 371 Date: Jan. 4, 2018

(30) Foreign Application Priority Data
Jul. 24, 2015 (DE) 10 2015 214 031.8
Jul. 24, 2015 (DE) 10 2015 214 033.4

(51) Int. Cl. F16H 48/11; F16H 48/40

(52) U.S. Cl. CPC F16H 48/11; F16H 2048/106; F16H 48/40

(57) ABSTRACT

A transmission arrangement for a motor vehicle, comprising a transmission input stage and a differential connected thereto via common planetary carrier, wherein the differential includes a first planetary set and a second planetary set, wherein the first planetary set meshes with a first sun gear and the second planetary set meshes with a second sun gear, and wherein the first and second planetary sets mesh with one another.

### CROSS-REFERENCE TO RELATED APPLICATIONS

This application is the U.S. National Phase of PCT/DE2016/200254 filed May 27, 2016, which claims priority to DE 10 2015 214 033.4 filed Jul. 24, 2015 and DE 10 2015 214 031.8 filed Jul. 24, 2015, the entire disclosures of which are incorporated by reference herein.

### TECHNICAL FIELD

The disclosure relates to a transmission arrangement for a motor vehicle, comprising a transmission input stage and a differential which is connected thereto via a common planetary carrier, wherein the differential has a first and a second planetary set, wherein the first planetary set meshes with a first sun gear and the second planetary set meshes with a second sun, and wherein the two planetary sets of the differential mesh with one another in pairs.

### BACKGROUND

The published patent application DE 10 2012 213 392 A1 discloses a transmission combination with an overlay stage which can be configured as an additional planetary stage, which is connected to a planetary gear set. The planetary gear set is equipped with at least two planetary stages, wherein each planetary stage is formed with at least one respective set of planet gears and one sun gear. The planet gears are arranged in such a way that they can rotate around bearing sections of a planetary carrier that comprises bolt axles. All bolt axles have the same radial distance from a main axle by means of the sun gears, around which the planetary carrier is mounted in a rotatable manner. The overlay stage features one common bolt that extends through one planet gear of the overlay level and also a planet gear of a first planetary set of the planetary gear set.

### SUMMARY

The disclosure may allow to further develop a transmission arrangement with a differential and to design it in a particularly compact way.

According to the disclosure, the transmission input stage comprises a drive sun gear, which meshes with the first planetary gears of a first planetary set, wherein one respective planetary gear of the first planetary set is connected to a second planetary gear of a second planetary set in a rotationally fixed manner. The two planetary gears of the planetary sets of the transmission input stage that are connected in a rotationally fixed manner are both mounted together on a respective first bolt that is arranged on the planetary carrier in such a way that they can rotate.

The first bolt may be arranged at the planetary carrier within recesses that are prepared for this purpose. The planetary gears of the planetary sets of the transmission input stage are pressed together via a form-fit or welded or arranged as a stepped planetary gear set. The differential hereby serves to distribute the input torque, that is supplied to the transmission arrangement via the drive sun gears, in half shares onto the two sun gears.

The second planetary set of the transmission input stage may mesh with a stationary fixed ring gear, wherein the two planetary sets of the differential are arranged radially within the ring gear. The ring gear is particularly stationarily fixed at a housing and thus connected to the housing in a way that it is rotationally fixed. By means of the arrangement of the two planetary sets of the differential radially within the ring gear, construction space is saved particularly in radial direction. The planetary gears of the two planetary sets of the differential have similar diameters, but their widths vary greatly. The widths of the two planetary gears and thus also of the planetary sets of the differential vary from each other at least by the factor 1.5. The planet gears of the two planetary sets of the transmission input stage furthermore features greatly differing diameters as well as greatly differing widths from set to set. The planetary gears of the first planetary set of the transmission input stage hereby feature a diameter that is at least double than the planetary gears of the second planetary set of the transmission input stage, wherein the widths of the first planetary set of the transmission input stage is at least half the size of the width of the second planetary set of the transmission input stage.

The planetary gears of the first planetary set of the differential may be mounted on a second bolt that is arranged on the planetary carrier in such a way that they can rotate. Consequently, only the respective planet gears of the second planetary set of the differential are mounted at the first bolt. The second bolt is arranged at the planetary carrier within recesses that are prepared for this purpose. In other words, the second bolt is intended to connect the transmission input stage with the differential. This connection is particularly compact and easy to mount.

The planetary gears of the second planetary set of the differential may be mounted on a third bolt that is arranged on the planetary carrier in such a way that they can rotate. Consequently, only the respective planet gears of the second planetary set of the differential are mounted on the third bolt. The third bolt is arranged at the planetary carrier within recesses that are prepared for this purpose. In other words, the third bolt is intended to connect the transmission input stage with the differential. This connection is particularly compact and easy to mount.

The planetary carrier may feature pockets to accommodate the respective planetary gears. In other words, one of the respective planet gears of the four planetary sets is arranged within one of the respective pockets at the planetary carrier. The respective planetary gears thereby feature different axial and radial measurements, wherein the respective pockets are designed accordingly.

The disclosure includes the technical teaching, that a planetary carrier can be designed in two parts and that it comprises a main element as well as a front plate that is connected to it in a rotationally fixed manner. The front plate is particularly axially attached to the main element via screw elements. For this purpose, axial bore holes are formed at the front plate and at the main element to accommodate the screw elements.

The first and the second sun gear may feature a plug-in toothing at a respective inner circumferential surface in order to connect to a respective drive shaft. The respective plug-in toothing realizes a form-fit connection between the respective drive shaft and the respective sun gear. The transmission arrangement can hereby be designed as a longitudinal transfer gearbox or as an axle differential. As far as the transmission arrangement is designed as an axle differential, the respective drive shaft is connected to one respective wheel of a motor vehicle.

According to one embodiment, the drive sun gear is designed as a ring gear. In this way it is possible to feed one of the two drive shafts through the ring gear and thus to achieve a reduction of construction space.

According to another embodiment, the drive sun gears and the two planetary sets of the transmission input stage are designed with a helical gearing. The two sun gears and the two planetary sets of the differential are designed with straight toothed gears.

### DETAILED DESCRIPTION OF DRAWINGS

Further measures that improve the disclosure are depicted in more detail by means of the figures in the following along with the description of the embodiments of the disclosure. It is shown:

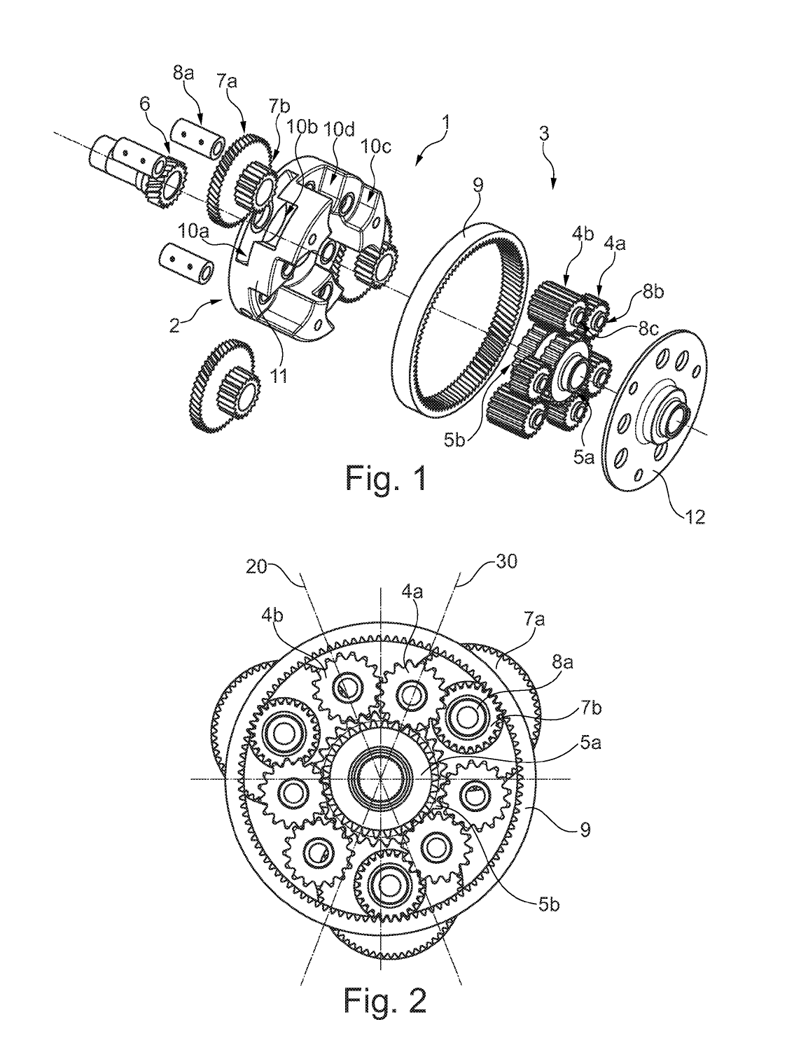

FIG. 1 discloses a schematic exploded view to illustrate the design of the transmission arrangement according to the disclosure,

FIG. 2 discloses a simplified schematic side view to illustrate the design of the transmission arrangement according to the embodiment in line with FIG. 1, wherein a first and a second intersecting line are depicted,

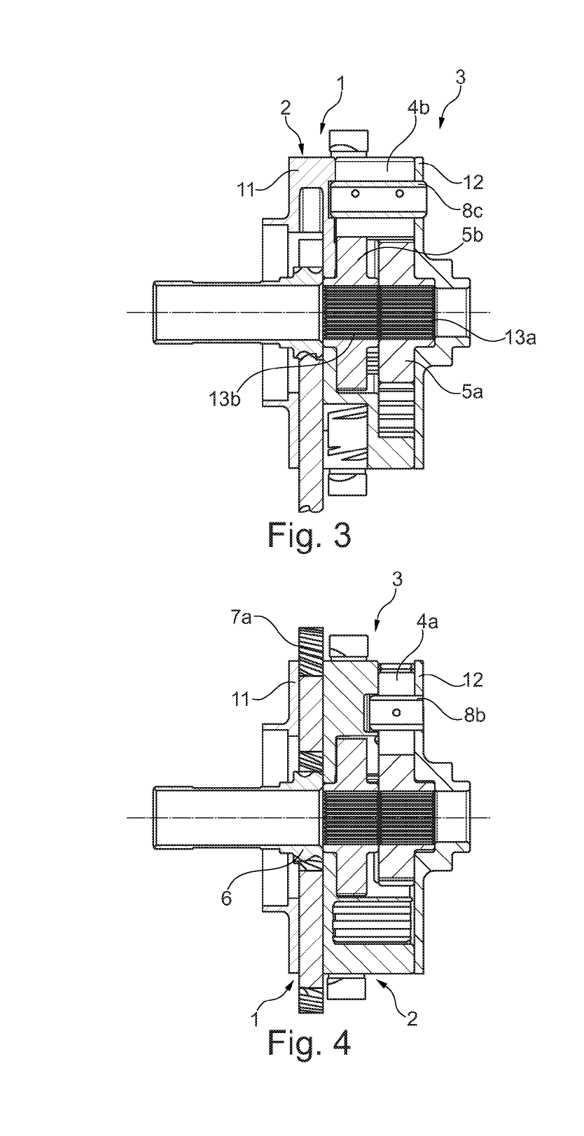

FIG. 3 discloses a schematic longitudinal depiction along the first intersecting line from FIG. 2 to illustrate the design of the transmission arrangement according to the disclosure, and

FIG. 4 discloses a schematic longitudinal depiction along the second intersecting line from FIG. 2 to illustrate the design of the transmission arrangement according to the disclosure.

### DETAILED DESCRIPTION

According to FIG. 1, a transmission arrangement according to the disclosure for a motor vehicle comprises a transmission input stage 1 and a differential 3 that is connected to it via a common planetary carrier 2. The transmission input stage 1 comprises a drive sun gear 6, a first and a second planetary set 7a, 7b, which is consisting of respective planetary gears, as well as a ring gear 9. One respective planetary gear of the first planetary set 7a is mounted together with one planetary gear of the second planetary set 7b on one common first bolt 8a.

In contrast, the differential 3 comprises a first and second planetary set 4a, 4b that is made up of planetary gears, as well as a first and second sun gear 5a, 5b. One respective planetary gear of the first planetary set is mounted on a second bolt 8b and one planetary gear of the third set is mounted on a third bolt 8c. Each one of the four planetary sets 4a, 4b, 7a, 7b comprises three planetary gears, which are designed as gear wheels.

The planetary carrier 2 features pockets 10a, 10b, 10c, 10d in order to accommodate the respective planetary gears of the planetary sets 4a, 4b, 7a, 7b. The respective pockets 10a, 10b, 10c, 10d are adapted in their measurements to the respective planet gears of the respective planetary set 4a, 4b, 7a, 7b. The drive sun gear 6 and the planetary gears of the two planetary sets 7a, 7b of the transmission input stage 1 are arranged with a helical gearing. In contrast, the two sun gears 5a, 5b and the planetary gears of the two planetary sets 4a, 4b of the differential 3 are arranged with straight toothed gears. The planetary carrier 2 is furthermore designed in two parts and features a main element 11 as well as a front plate 12 that is connected to it in a rotationally fixed manner. The front plate 12 is axially attached to the main element 11 via—not depicted—screw elements.

FIG. 2 depicts a simplified side view of the transmission arrangement according to the embodiment from FIG. 1. For reasons of simplification, a depiction of the planetary carrier 2 was omitted. Two intersecting lines 20, 30 are depicted in FIG. 2, wherein the section along the first intersecting line 20 is depicted in FIG. 3 and the section along the second intersecting line 30 is depicted in FIG. 4. According to FIG. 2, the first intersecting line 20 runs through the center of one planet gear of the second planetary set 4b of the differential 3, while the second intersecting line 30 runs through the center of one planet gear of the first planetary set 4a of the differential 3. The two planetary sets 4a, 4b of differential 3 are meshing with each other in pairs. Furthermore, the first planetary set 4a meshes with a first sun gear 5a and the second planetary set 4b meshes with a second sun gear 5b. One respective planetary gear of the first planetary set 7a of the transmission input stage 1 is connected to one planetary gear of the second planetary set 7b of the transmission input stage 1 in a rotationally fixed manner. The second planetary set 7b of the transmission input stage 1 meshes with the stationarily fixed ring gear 9. Furthermore, the planetary gears of the two planetary sets 7a, 7b of the transmission input stage 1 are rotatably mounted together in pairs on the first bolt 8a that is arranged on the planetary carrier 2.

According to FIG. 3, the planetary gears of the second planetary set 4b of the differential 3 are mounted on a third bolt 8c that is arranged on the planetary carrier 2 in such a way that they can rotate. The transmission input stage 1 is transmissionaly connected to differential 3 via the third bolt 8c that is arranged at the planetary carrier 2, between the main element 11 and the front plate 12. Furthermore, the first and the second sun gear 5a, 5b feature a plug-in toothing 13a, 13b at a respective inner circumferential surface in order to connect to a respective drive shaft. The transmission arrangement can be designed as a transverse distributor between two wheels as well as a longitudinal distributor between one front or rear axle.

According to FIG. 4, the drive sun gear 6 meshes with the first planetary set 7a of the transmission input stage 1. The drive sun gear 6 may be designed as a ring gear. The transmission input stage 1, is transmissionaly connected to differential 3 via the second bolt 8b that is arranged at planetary carrier 2 between the main element 11 and the front plate 12.

### LIST OF THE REFERENCE SIGNS

1 Transmission input stage
2 Planetary carrier
3 Differential
4a, 4b Planetary set
5a, 5b Sun gear
6 Drive sun gear
7a, 7b Planetary set
8a-8c Bolt
9 Ring gear
10a-10d Pockets
11 Main element
12 Front plate
13a, 13b Plug-in toothing
20 first intersecting line
30 second intersecting line

1. Transmission arrangement for a motor vehicle, comprising:
a transmission input stage and a differential connected using a common planetary carrier, wherein the differential includes a first and a second planetary set with planetary gears, wherein the planetary gears of the first planetary set mesh with a first sun gear and the planetary gears of the second planetary set mesh with a second sun gear, and wherein the planetary gears of the two planetary sets of the differential are configured to mesh with one another in respective pairs,
wherein the transmission input stage includes one drive sun gear that meshes with a first planetary set, wherein one respective planetary gear of the first planetary set is rotationally fixed with a planetary gear of a second planetary set, and wherein the two respective rotationally fixed planetary gears of the planetary sets of the transmission input stage are respectively rotatably mounted together on a first bolt arranged at the planetary carrier.

2. The transmission arrangement of claim 1,
wherein the second planetary set of the transmission input stage meshes with a fixed ring gear, wherein the two planetary sets are radially arranged within the ring gear.

3. The transmission arrangement of claim 1,
wherein the planetary gears of the first planetary set are mounted on a second bolt that is rotatably arranged on the planetary carrier.

4. The transmission arrangement of claim 1,
wherein the planetary gears of the second planetary set are mounted on a third bolt that is rotatably arranged on the planetary carrier.

5. The transmission arrangement of claim 1,
wherein the planetary carrier features pockets configured to accommodate the planetary gears of the respective planetary sets.

6. The transmission arrangement of claim 1,
wherein the planetary carrier includes a main element and a front plate that is connected to the planetary carrier in a rotationally fixed manner.

7. The transmission arrangement of claim 1,
wherein the first and the second sun gear include a plug-in toothing at a respective inner circumferential surface.

8. The transmission arrangement of to claim 1,
wherein the drive sun gear is a ring gear.

9. The transmission arrangement of claim 1,
wherein the drive sun gear and the planetary gears of the two planetary sets of the transmission input stage are arranged with a helical gearing.

10. The transmission arrangement of claim 1,
wherein the two sun gears and the planetary gears of the two planetary sets of the differential are arranged with straight toothed gears.

11. A transmission arrangement for a motor vehicle, comprising:
a transmission input stage and a differential connected thereto via common planetary carrier, wherein the differential includes a first planetary set and a second planetary set, wherein the first planetary set meshes with a first sun gear and the second planetary set meshes with a second sun gear, and wherein the first and second planetary sets mesh with one another.

12. The transmission arrangement of claim 11, wherein the first planetary set is connected to the second planetary set in a rotationally fixed manner.

13. The transmission arrangement of claim 12, wherein the first planetary set and second planetary set are both mounted together on a respective first bolt.

14. The transmission arrangement of claim 13, the first bolt is arranged within a recess of the planetary carrier within a recess.

15. The transmission arrangement of claim 11, wherein the differential is configured to distribute input torque.

16. The transmission arrangement of claim 11, wherein the planetary carrier includes a first pocket configured to accommodate the first planetary set.

17. The transmission arrangement of claim 11, wherein the first sun gear includes a plug-in toothing.

18. The transmission arrangement of claim 11, wherein the first sun gear is a ring gear.

19. A transmission arrangement for a motor vehicle, comprising:
a drive sun gear configured to mesh with planetary gears of a first planetary set, wherein in one planetary gear of the first planetary set is connected to planetary gears of a second planetary set to rotate with it, and wherein the planetary gears of the first and second planetary sets of a transmission input stage are mounted rotatably jointly in pairs on a pin that is arranged on a planetary carrier connected to the transmission input stage and a differential.

20. The transmission arrangement of claim 19, wherein the transmission input stage is connected to a differential using a second pin that is arranged on the planetary carrier.
